(19) United States
(12) Patent Application Publication
(10) Pub. No.: US 2009/0266002 A1
(43) Pub. Date: Oct. 29, 2009

(54) POLISHING PAD AND METHOD OF USE

(76) Inventor: Rajeev Bajaj, Fremont, CA (US)

Correspondence Address: SONNENSCHEIN NATH & ROSENTHAL LLP, P.O. BOX 061080, WACKER DRIVE STATION, WILLIS TOWER, CHICAGO, IL, 60606-1080, US

(21) Appl. No.: 12/431,119

(22) Filed: Apr. 28, 2009

Related U.S. Application Data
(60) Provisional application No. 61/048,785, filed on Apr. 29, 2008.

(51) Int. Cl. B24D 3/00; B29C 45/00

(52) U.S. Cl. 51/298; 264/328.14

(57) ABSTRACT

Polishing pads of varying compositions for use in chemical mechanical planarization (CMP) and methods of manufacturing and using such pads. Examples of such polishing pads include two phases, one of which may be a high modulus, low wear material that maintains a stable texture when subject to a conditioning process (e.g., polyoxymethylene, Delrin, polyamide-imide (Torlon), polyetheretherketone (PEEK), and/or polysulfone), and the other of which may be a material having a polishing ability (e.g., a polyurethane material).

### RELATED APPLICATIONS

This application relates to, is a Non-Provisional of and incorporates by reference U.S. Provisional Patent Application No. 61/048,785, filed Apr. 29, 2008, which application is assigned to the assignee of the present invention.

### FIELD OF THE INVENTION

The present invention relates to the field of chemical mechanical planarization (CMP) and relates specifically to polishing pads for use in CMP designed for an extended useful life.

### BACKGROUND OF THE INVENTION

In modern integrated circuit (IC) fabrication, layers of material are applied to embedded structures previously formed on semiconductor wafers. Chemical Mechanical Planarization (CMP) is an abrasive process used to remove these layers (or portions thereof) and polish the resulting surface to achieve a desired structure. CMP may be performed on both oxides and metals and generally involves the use of chemical slurries applied in conjunction with a polishing pad in motion relative to the wafer (e.g., the pad rotates relative to the wafer with the slurry dispersed therebetween). The resulting smooth flat surface is necessary to maintain photolithographic depth of focus for subsequent wafer processing steps and to ensure that the metal interconnects are not deformed over contour steps. Damascene processing requires metal, such as tungsten or copper, to be removed from the top surface of a dielectric to define interconnect structures, using CMP.

Polishing pads used in CMP are typically made of urethanes either in cast form and filled with micro-porous elements or from non-woven felt coated with polyurethanes. During polishing operations, the polishing pad is rotated while contacting the wafer, which is also rotating, thus effecting polishing. One aspect of polishing pads is that during polishing the polishing pad material undergoes plastic deformation that leads to deterioration of the pad's polishing ability. For example such deformation during a polishing process results in that process becoming non-uniform and, as a result, the polishing operation can be accomplished only at a much lower removal rate.

In order to restore polishing performance and achieve consistent polishing performance, the polishing pad surface is periodically abraded with a disk covered with fine grit diamond particles. The purpose of such conditioning is to remove the worn top layer of the pad and restore the texture of the top surface so as to effect consistent polishing. Such conditioning processes are well accepted for polishing processes employing hard pads. In the case of soft pads, however, conditioning processes are not as well accepted and, as such, tend to result in reduced useful lifetimes of such pads.

Conditioning processes introduce several challenges for polishing processes overall. For example, the effectiveness of a conditioning process changes over time—a new conditioning disk may regenerate the polish pad surface very efficiently at first, but after several uses the effectiveness of the disks is reduced due to reduction in the sharpness of diamonds. It is also a source of process variation as consistency of diamond disks over their individual lifetimes and disk-to-disk is a matter of concern. Another significant concern is the potential for individual diamonds to come loose from the conditioning disk and fall onto the polishing pad; leading to severe scratching and catastrophic loss of the wafer product. Further, while conditioning processes improve process stability, periodic removal of the top layer of a polishing pad does lead to a finite lifetime of the subject pad as determined by conditioning process induced wear of the pad. It is therefore an objective of the present invention to optimize conditioning processes to, for example, remove only as much of the polishing pad as is necessary to maintain the pad's polishing performance.

### SUMMARY OF THE INVENTION

Embodiments of the invention provide polishing pads of varying compositions for use in chemical mechanical planarization (CMP) and methods of manufacturing and using such pads.

In one embodiment, a polishing pad may include a first phase and a second phase. The first phase may comprise a high modulus, low wear material that maintains a stable texture when subject to a conditioning process. Exemplary first phase materials include a polyoxymethylene material, Delrin, polyamide-imide (Torlon), polyetheretherketone (PEEK), and/or polysulfone. The second phase may comprise a material having a polishing ability such as a polyurethane material. The second phase or polyurethane content of the polishing pad may range from 1 to 99% of the polishing pad.

In some cases, the material included in the first phase may be a bulk phase and the material included in the second phase may be a dispersed phase having a domain size of 200 microns or less. In other cases, the material included in the second phase may be a bulk phase and the material included in the first phase may be a dispersed phase having a domain size of 200 microns or less.

In another embodiment, a CMP polishing pad may include a bulk phase and a dispersed phase. The polishing pad may include 5%-95% polyurethane material by weight and a polyoxymethylene material. The polyurethane material may have a hardness greater than Shore D 25, a modulus greater than 1000 pounds per square inch (psi), and a glass transition temperature below 20° C. The dispersed phase may have a size of 200 microns or less.

In some cases, the polishing pad may also include a compatibilizer. The compatibilizer may act to control the size of the dispersed phase and/or provide adhesion between the polyurethane material and the polyoxymethylene material. The compatibilizer may comprise 0.5-5% of the weight of the polishing pad. The compatibilizer may include, for example, methyl di-isocyanate (MDI), toluene di-isocyanate (TDI), and/or ethyl di-isocyanate (EDI).

In a further embodiment, a CMP polishing pad may include a bulk phase and a dispersed phase, wherein the a size of the dispersed phase is 200 microns or less. The bulk phase may be made of a combination of polyurethane and polyoxymethylene and the combination may have one or more of the following properties: a tensile strength greater than 1000 psi, a flexural modulus greater than 2000 psi, and a Shore D hardness greater than 25.

Another embodiment includes a CMP polishing pad that may include one or more polishing elements, the polishing elements may be made from a polyurethane-polyoxymethylene polymer blend having one or more of following properties, a microporosity of 1%-20% by volume, a plurality of micropores having a size of 20-100 microns; a tensile strength greater than 1000 psi, a flexural modulus greater than 2000 psi, and a Shore D hardness greater than 25.

A method of manufacturing a polishing pad for use in CMP may include using an injection molding process, an extrusion process, a reaction injection molding process and/or a sintering process to perform the following operations: disperse polyoxymethylene particles in a urethane precursor mix prior to a urethane forming reaction, melt-mix the polyoxymethylene particles and a thermoplastic polyurethane material, and inject the melt-mixed polyoxymethylene particles and the thermoplastic polyurethane material into a mold to form the polishing pad. In some cases, the polyoxymethylene particles and the thermoplastic polyurethane material may be mixed in-line using an injection-molding machine.

These and further embodiments of the invention are discussed in detail below.

### BRIEF DESCRIPTION OF DRAWINGS

The present invention is illustrated by way of example, and not limitation, in the figures of the accompanying drawings, in which:

FIGS. 1(a) and 1(b) show cross-sections of different classes of polishing pads which, despite their differences, may be manufactured and used in accordance with embodiments of the present invention;

FIG. 2(a) shows a magnified view of a polishing pad or polishing element/surface made of a polyurethane-Delrin blend in accordance with an embodiment of the present invention; and

FIG. 2(b) shows a close up of a single dispersed phase particle in a matrix of a polishing pad or element, consistent with an embodiment of the present invention.

### DETAILED DESCRIPTION

Disclosed herein are a polishing pad with reduced conditioning requirements and materials useful for making polishing pads with reduced need for conditioning. A polishing pad with immiscible polymers is also disclosed.

Conventional polishing pads are made of polymers, typically urethane, having structures to provide means for distributing slurry under the wafer during polishing processes. These structures include voids or micro-pores that are included by adding hollow micro-elements as described in U.S. Pat. No. 5,578,362 or through the introduction of bubbles formed during a casting process. U.S. Pat. No. 6,896,593 describes the use of supercritical CO₂ to form pores during molding processes.

Once the pad layer is formed, it may be further machined on the top surface by mechanical or laser means to add grooves. During polishing processes, pads may be conditioned using a fine diamond-coated disk to create a micro-texture that creates micro-groove channels to further enhance slurry distribution under the wafer. During wafer polishing processes, the pad surface typically undergo plastic deformation, which reduces slurry distribution leading to poor material removal and removal uniformity characteristics.

Conditioning processes remove the plastic deformation layer and restore polishing performance. In the case of poor slurry distribution between the pad and wafer, there is a potential for slurry-poor regions under the wafer to cause direct pad-to-wafer contact, leading to defects in the wafer. All commercially available hard polishing pads today require conditioning with every polishing cycle and soft pads have limitations to pad life due to plastic deformation. While urethane materials offer advantages in polishing performance, loss of conditioning texture which enables local slurry transport over a short use (e.g., approximately 1-10 minute of polish time) is a significant issue relating to material properties.

It is therefore an objective of the present invention to provide polishing pad materials, which undergo reduced plastic deformation during polishing operations. There are several commercially available polymer materials, which would suffer little or no plastic deformation under polishing conditions, however these materials tend to have very high tensile modulus and high shore hardness (e.g., greater than approximately Shore D 80). Pads made from hard (e.g., approximately shore D 75-85) polymers typically show higher scratch defects in the wafer. In addition some materials do not have compatibility with polishing slurries and show poor wafer-film removal rates.

It is therefore desirable to develop polishing pad materials that retain the advantages of polyurethane-based polishing pads while offering improved polishing performance with respect to their need for conditioning. A significant aspect of material requirement is that the materials be easy to texture using diamond conditioning and at the same time not have significant wear under sliding contact. In other words, the materials need to have wear under abrasive wear and have very little wear under sliding wear conditions.

One method of producing polymers with diverse properties is to combine polymers to form polymer alloys or blends. Through mixing existing polymers, entirely new combinations of properties can be achieved. Herein is disclosed polishing pads made from polymer blends that separate into more than one distinct phase. One phase is a high modulus material and forms a low wear phase. This phase has high modulus and maintains stable texture during polishing processes. The second phase is the polishing phase and provides polishing ability. The morphology, shape, and size of these two phases are important considerations in achieving a best overall polishing performance. The interface characteristics are also important in determining final pad performance. Phase size and shape play an important role and phase size is especially important.

The relative domain size of the low wear, stable textured phase and the size of the urethane phase determine stability of polish performance over a long period of time (e.g., greater than approximately 10-15 minutes). For example, polyurethane content in polyurethane-polyoxymethylene (POM) may be varied from as little as 1% to as much as 99%. Initially, polyurethane may be dispersed in polyoxymethylene. The polyoxymethylene phase provides a stable texture phase while the polyurethane provides a polishing phase. In this case, polyurethane is embedded in a stable texture—even so, the relative size of the polyurethane phase is important as the primary polish phase carries slurry across the entire phase. A nominal order of the polyurethane phase size is 20 micron-500 micron and smaller size is preferred. In the opposite case of 99% polyurethane, polyoxymethylene phase size is important as the relative spacing between phases will determine the efficiency of slurry transport, water or polishing solution and thereby provide a very low defectivity polishing surface.

With the above in mind, a more detailed discussion of the present polishing pads and methods of producing same is provided.

As previously noted, in CMP processes, conditioning plays an important role in establishing a stable repeatable process with good removal rate and uniformity. U.S. Pat. No. 5,216,843 describes a diamond holder which creates a plurality of groves on a pad surface for improved polish performance. Diamond conditioning is necessary to eliminate the top layer of the pad due to plastic deformation of the pad's polishing surface, which affects slurry flow and distribution across the wafer substrate being polished.

At the same time, polishing pad materials have several requirements, among which is an ability to polish, in combination with the slurry, a silicon substrate or any desired film deposited or grown on the surface of the substrate (such as silicon dioxide, copper, tungsten, etc.). The polishing pad material must afford good removal rates, be capable of planarizing surface features on the top layer of a wafer, and also be soft enough so as to not cause scratching on the surface of the film being polished.

Typically, polishing pads are made of continuous layers of polyurethane, which may incorporate microelements or voids introduced by other means. The surface may additionally be machined with grooves to improve slurry flow and slurry distribution across the wafer surface during polish. Micro-porosity has been shown to be an important contributor to process stability. In the absence of conditioning, micro-porous pads are capable of maintaining removal rates much better than solid pads. In solid pads the texture is controlled primarily by conditioning while micro-porosity offers an additional means of distributing slurry across the wafer-pad interface. However, deterioration of polish performance in the absence of conditioning remains an issue for both cases. It is therefore an objective of the present invention to provide polishing materials that undergo minimal plastic flow under polishing conditions and are therefore able to maintain surface texture for stable performance during a polishing process.

In one embodiment of the invention, polishing pads are made from blends of polyurethane and polyoxymethylene (or Delrin™). Delrin is a widely used engineering resin made by Dupont Co. Delrin has excellent mechanical properties and also offers very low friction and wear properties, which makes it an ideal material for replacement of metal parts and long cycle use applications. Delrin, however, has low impact strength and tends to undergo brittle fracture under impact. Polyurethane-polyoxymethylene blends have been widely studied for improved toughness and impact resistance over Delrin alone. In tests performed by the present inventor, pads made from Delrin alone exhibited low removal rates for dielectric and tungsten films. In some cases higher removal rates for copper films were observed, but this was primarily attributable to slurry chemistry. Delrin also showed high material wear rates during conditioning.

In conventional polishing evaluations, both of the above-described results (high pad wear rate and low removal rate) are significantly opposite those of desired characteristics. Further tests of solid Delrin polishing pads without conditioning for copper processing were surprising, however, because the pads showed no deterioration in removal rate or uniformity due to lack of conditioning. The inventor attributes these results to the ability of Delrin to maintain textures induced by conditioning processes under the sliding wear conditions of polishing processes. A pad made, in accordance with the present invention, of a combination of polyurethane and Delrin is therefore expected to combine the performance benefits of both materials.

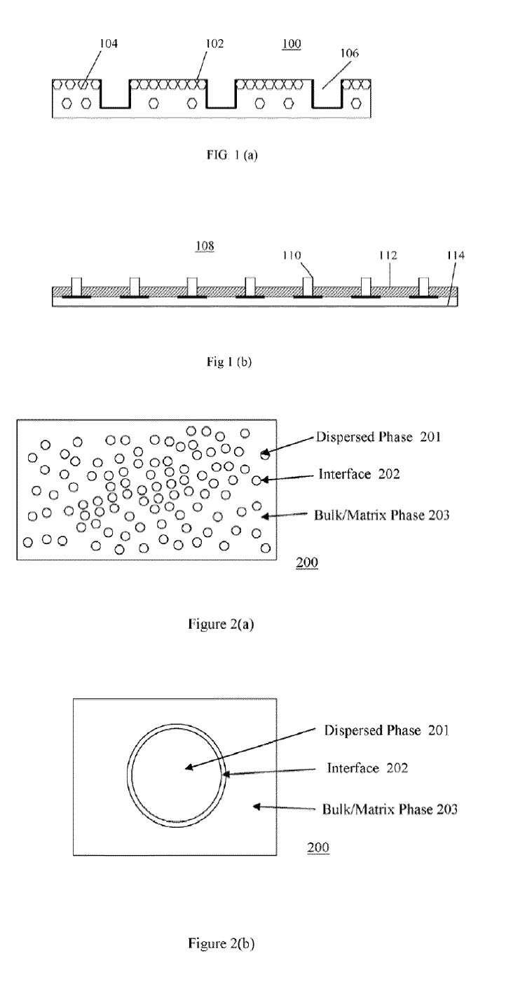

FIG. 1(a) is a profile cutaway view of a class of polishing pads, such as the IC 1000 pads of Rohm and Haas, which may be updated by being manufactured and used in accordance with the present invention. Polishing pad 100 contains microelements 102 embedded in a polymeric matrix 104, which may be polyurethane. The pad surface contains grooves 106 for slurry transport during polishing processes. Polishing pads of this variety provide multiple surface modifications to effect slurry distribution across the surface of the pad.

FIG. 1(b) shows a cross-section of a polishing pad 108 made by SemiQuest, Inc. This polishing pad 108 is an engineered structure and is described in U.S. patent application Ser. No. 11/697,622, filed Apr. 6, 2007, assigned to the assignee of the present invention and incorporated herein by reference. Pad 108 consists of polishing elements 110, which rest on a compressible under-foam 114 and are supported in vertical orientation by a guide plate 112. Polishing action is provided by the polishing elements, which are made of a solid polymer material, while slurry distribution is effected by the open spaces between the polishing elements. The open space is filled with open cell foam.

In accordance with embodiments of the present invention, the polishing surfaces 104 and 110 of these two different polishing pads may be made advantageously by using materials described herein.

FIG. 2(a) shows a magnified view of a polishing pad or polishing element/surface 200 made of a polyurethane-Delrin blend. In this case the dispersed phase 201, which may be Delrin or polyurethane, is distributed in a matrix or bulk phase 203, which may be polyurethane or Delrin, respectively. In a well mixed system, the size of the particles that make up the dispersed phase is on the order of 10-20 microns and the phase boundary 202 is distinct. FIG. 2(b) shows a close up of a single dispersed phase particle in the matrix. Due to large differences in polarity and interfacial tension, the interface is smooth and the two surfaces show no adhesion.

In various embodiments then, the present invention provides a polishing pad having one or more polishing elements or surfaces made from a polymer blend of low wear material and polyurethane, where
(1) the low wear polymer material is the bulk phase and polyurethane is the dispersed phase;
(2) the low wear material is selected from among: Delrin, polyamide-imide (Torlon), polyetheretherketone (PEEK), and polysulfone; and
(3) the domain size of the dispersed phase is 200 microns or less.

In further embodiments, a polishing pad configured in accordance with the present invention includes one or more polishing elements or surfaces made from a polymer blend of low wear material and polyurethane, where:
(1) the low wear material is the dispersed phase and polyurethane is the bulk phase;
(2) the low wear material is selected from among: Delrin, polyamide-imide (Torlon), polyether-ether (PEEK), and polysulfone; and
(3) the domain size of the dispersed phase is 200 microns or less.

Another embodiment of the present invention provides a polishing pad having one or more polishing elements or surfaces made from a combination of polyurethane and poly-oxymethylene, wherein:
(1) polyurethane content is 5%-95% by weight;
(2) polyurethane hardness is greater than Shore D 25;
(3) polyurethane modulus is greater than 1000 pounds per square inch (psi);
(4) polyurethane glass transition temperature is below 20° C.; and
(5) the size of the dispersed phase is 200 microns or less.
   The blend for this pad may additionally contain a compatibilizer to control the size of the dispersed phase and improve adhesion between the polyurethane and poly-oxymethylene. The compatibilizer may be selected from, for example, methyl di-isocyanate (MDI), toluene di-isocyanate (TDI), or ethyl di-isocyanate (EDI). The compatibilizer may be in the range of 0.5-5% by weight.

Yet another polishing pad configured in accordance with the present invention includes one or more polishing elements or surfaces made from a combination of polyurethane and poly-oxymethylene and has the following properties:
(1) tensile strength greater than 1000 psi;
(2) flexural modulus greater than 2000 psi;
(3) Shore D hardness greater than 25; and
(4) the size of the dispersed phase is 200 microns or less.

Still another embodiment of a polishing pad configured in accordance with the present invention includes one or more polishing elements or surfaces made from a polyurethane-polyoxymethylene polymer blend having following properties:
(1) microporosity in the range 1%-20% by volume;
(2) micropores having a size in the range of 20-100 microns;
(3) tensile strength greater than 1000 psi;
(4) flexural modulus greater than 2000 psi; and
(5) Shore D hardness greater than 25.

An embodiment of the invention includes a method in which a polishing pad or polishing element/surface made from blend of polyurethane and polyoxymethylene is attached to, or mounted on, a polishing table, and a silicon wafer is pressed against the pad with force while the pad and/or the wafer is rotating and in the presence of a polishing fluid so as to remove a film on the top surface of the silicon wafer. A further embodiment provides a method of manufacturing such a pad using injection molding, extrusion, reaction injection molding or sintering. In various of these instances, polyoxymethylene particles may be dispersed in a urethane precursor mix prior to a urethane forming reaction; poly-oxymethylene and thermoplastic polyurethane may be melt-mixed and subsequently injected into a mold to form the pad; or poly-oxymethylene and thermoplastic urethane may be mixed in-line in an injection molding machine used for forming the pad.

Thus, a polishing pad for use in CMP has been described. Although discussed with reference to various examples, the present invention is not intended to be limited thereby and should only be measured in terms of the claims, which follow.

What is claimed is:

1. A polishing pad for use in chemical mechanical planarization (CMP) comprising:
a first phase, wherein the first phase comprises a high modulus, low wear material that maintains a stable texture when subject to a conditioning process; and
a second phase, wherein the second phase comprises a material having a polishing ability.

2. The polishing pad of claim 1, wherein the first phase includes a polyoxymethylene material and the second phase includes a polyurethane material.

3. The polishing pad of claim 2, wherein the polyurethane content of the polishing pad ranges from 1 to 99% of the polishing pad.

4. The polishing pad of claim 1, wherein the material included in the first phase is a bulk phase and the material included in the second phase is a dispersed phase having a domain size of 200 microns or less.

5. The polishing pad of claim 1, wherein the first phase includes at least one of Delrin, polyimide-amide (torlon), polyetheretherketone (PEEK), and polysulfone.

6. The polishing pad of claim 1, wherein the material included in the second phase is a bulk phase and the material included in the first phase is a dispersed phase having a domain size of 200 microns or less.

7. A chemical mechanical planarization (CMP) polishing pad comprising:
a bulk phase and a dispersed phase, wherein:
the polishing pad includes polyurethane material of 5%-95% by weight and polyoxymethylene material; the polyurethane material has a hardness greater than Shore D 25; a modulus greater than 1000 pounds per square inch (psi); and a glass transition temperature below 20° C.; and
the dispersed phase has a size of 200 microns or less.

8. The polishing pad of claim 7, further comprising:
a compatibilizer, to control the size of the dispersed phase and provide adhesion between the polyurethane material and the polyoxymethylene material.

9. The polishing pad of claim 8, wherein the compatibilizer includes at least one of methyl di-isocyanate (MDI), toluene di-isocyanate (TDI), and ethyl di-isocyanate (EDI).

10. The polishing pad of claim 8, wherein the compatibilizer comprises 0.5-5% by weight of the polishing pad.

11. A chemical mechanical planarization (CMP) polishing pad comprising:
a bulk phase and a dispersed phase having a size of the 200 microns or less, and is made of a combination of polyurethane and polyoxymethylene, wherein the combination has the following properties:
a tensile strength greater than 1000 psi;
a flexural modulus greater than 2000 psi; and
a Shore D hardness greater than 25.

12. A chemical mechanical planarization (CMP) polishing pad comprising one or more polishing elements, the polishing elements made from a polyurethane-polyoxymethylene polymer blend having following properties:
a microporosity of 1%-20% by volume;
a plurality of micropores having a size of 20-100 microns;
a tensile strength greater than 1000 psi;
a flexural modulus greater than 2000 psi; and
a Shore D hardness greater than 25.

13. A method of manufacturing a polishing pad for use in chemical mechanical planarization (CMP), comprising:
using at least one of an injection molding process, an extrusion process, a reaction injection molding process and a sintering process to perform the following operations:
disperse polyoxymethylene particles in a urethane precursor mix prior to a urethane forming reaction;
melt-mix the polyoxymethylene particles and a thermoplastic polyurethane material; and
inject the melt-mixed polyoxymethylene particles and the thermoplastic polyurethane material into a mold to form the polishing pad.

14. The method of claim 13, wherein the polyoxymethylene particles and the thermoplastic polyurethane material are mixed in-line using an injection-molding machine.
